(19) United States
(12) Patent Application Publication
(10) Pub. No.: US 2007/0261567 A1
(43) Pub. Date: Nov. 15, 2007

(54) Pan assembly for cooking a food item with a depression in same

(76) Inventor: Fletcher Morgan, St. Petersburg, FL (US)

Correspondence Address: JOHN S. HALE;GIPPLE & HALE, 6665-A OLD DOMINION DRIVE, MCLEAN, VA, 22101, US

(21) Appl. No.: 11/471,550

(22) Filed: Jun. 21, 2006

Related U.S. Application Data
(63) Continuation-in-part of application No. 29/259,483, filed on May 10, 2006, now Pat. No. D541583.

(51) Int. Cl. A47J 37/10

(52) U.S. Cl. 99/422

(57) ABSTRACT

A cooking pan assembly comprising; a top pan body pivotally mounted to a bottom pan body, the bottom pan body defining a reservoir and having a handle mounted extending from the bottom pan body and a middle pan body defining a reservoir which has a lesser surface area than that of the bottom pan reservoir mounted to the bottom pan with the middle pan body extending into the reservoir of the bottom pan. The middle pan is constructed with a pan body having a side wall defining a cavity and a flat bottom, a handle secured to the pan body and an elevation support member extending from the side wall opposite the handle. The bottom pan is provided with an angled elevation member defining a plurality of parallel slots which receive the elevation support member of the middle pan.

### RELATED APPLICATIONS

There is a co-pending design application Ser. No. 29/259,483 filed May 10, 2006.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

None.

### FIELD OF THE INVENTION

The present invention generally to a cooking pan assembly which can be rotated 180° during the cooking process on a conventional stove burner and more specifically to a cooking pan assembly having a middle pan which can be elevated to selective heights to form a food item with a depression or cavity in the center of same.

### BACKGROUND OF THE INVENTION

The cooking of food products that start from a liquid batter (such as pancakes and omelets) and subsequently solidify during the cooking process traditionally require that during the cooking process, the cook use a hand-held spatula, that must be inserted between the partially cooked food and the pan to turn over the food product so that the food product can be cooked on both sides. The action of the spatula sometime causes tearing of the finished product so that it does not have the desired appearance or ruins the presentation of the dish. Furthermore, such a cooking procedure makes it difficult to obtain a final cooked product which can be filled with another food component or filling such as whipped cream, sauces, fruit, nuts or the like unless the flat pancake or omelet is rolled which generally causes breaking and tearing of the finished product. Cooking pancakes or omelets requires constant monitoring of the pancake or omelet liquid and some agility on the part of the cook in turning over the food with a spatula with an additional step required once the cooking is complete, in that the food product must be carefully removed with a spatula from the concave pan to a plate for serving. Often the food product is much larger than the spatula, providing an opportunity for the food product to break apart during transfer. Because of the concave nature of typical cooking pans, the cook must insert a spatula below the cooked material and carefully remove the cooked product from the pan by moving the food over the concave side of the pan for serving the food. Because of the nature of cooking of these food products it is difficult to create a finished product which can be filled with another food filling. It is also important to have a high-quality cooking pan in which heat is transferred uniformly throughout the conductive heat surface and the use of iron skillets, aluminum, or copper pans for accomplishing same is well known. Currently manufactured pans often include a non-stick coating on the top surface of the metal pan known under the trademark of TEFLON. The pan cooking surfaces are coated to prevent sticking of eggs or pancake batter to the pan thus allowing easier spatula entry and to allow easier cleaning of the pans.

The prior art discloses several different approaches to the uniform cooking of pancakes, griddlecakes or omelets with an attempt to alleviate human frailty with a hand-held spatula in the cooking process.

The present invention overcomes the problems of the prior art by providing a three piece pan assembly for cooking pancakes, omelets and other food articles that begin as a liquid and firm up to be a solid or partial solid when the cooking process has been completed. The pan assembly during the cooking process forms a depression, cavity or hollow area which can be filled with another food substance such as fruit, meat, cheese, vegetables or combinations of same. The single food article created by the present pan assembly can also be used in preparing wrapped dishes such as crepes, burritos, tamales or blintzes. The assembly can also be used as previously noted to produce compound food articles containing a filling such filled pancakes, omelets, pita or other sandwiches or calzone. The top and bottom pans are hinged together with spaced apart hinges which pivot on a cylindrical rod. Both the top and bottom pan also have handles which when the pan assembly is closed operate as a single handle with the bottom pan being provided with an elevation member for supporting the middle pan during cooking. The initial food in liquid form is poured into a flat bottom surface of the concave section of the bottom pan and the middle pan is placed into a desired slot of the bottom pan elevation member so that the bottom surface of the middle pan engages the liquid in the concave section of the bottom pan forming a depression in the cooked product. Once the cooked material solidifies sufficiently, the entire pan can be flipped 180°. The cooked material now rests on the flat cooking surface of the bottom of the middle pan and the flat section of the top pan until cooking is complete. The cooked food can than easily be removed by opening the pan assembly via its hinges and transferred to a plate by gravity without having to use a spatula with the final cooked product being formed with a depression or reservoir which can hold a filling or another cooked product.

One early type griddle device is shown in U.S. Pat. No. 1,410,818 issued Mar. 28, 1922. This griddle has two members in the form of a substantially flat pan which is mounted by lug means to a lower pan formed with three depressions into which the batter is to be poured. Each pan has an adjacent hollow handle with an insulating sleeve such as asbestos.

Another cooking appliance with a reversible grill is disclosed in U.S. Pat. No. 4,011,431 issued Mar. 8, 1977. This cooking appliance has a flat section and a concave section which are hinged together.

One current commercial pancake cooking pan is shown in U.S. Pat. No. 6,539,844 issued Apr. 1, 2003 which discloses a first concave cooking container that is joined by spaced hinges to a flat top cooking body. Both the container and cooking body have parallel handles which function as a single handle that allow the pan to be rotated 180 degrees during the cooking process. The final cooked food product can slide by gravity from the flat cooking body without a spatula.

Another similar cooking pan is shown in U.S. Pat. No. 6,681,683 issued Jan. 27, 2004 which also has hinged flat and concave cooking bodies with the hinge brackets being joined by a bar with a circular cross section. Another cooking pan similar to the previously noted cooking pan also is provided with a flat cooking surface as is shown in U.S. Pat. No. 6,550,374 which issued Apr. 22, 2003. This cooking pan includes a first cooking container with a handle having three circular wells which hold the poured batter for cooking three pancakes simultaneously that is joined by spaced hinges to a flat cooking body having a parallel handle to that of the other cooking container so that the device can be rotated 180 degrees during the cooking process.

### SUMMARY OF THE INVENTION

A cooking pan assembly comprising a top pan, a middle pan and a bottom pan for cooking liquid foods that can be solidified during the cooking process to provide a depression, cavity or hollow area in the center of the cooked foodstuff to hold a food filling or added food product thereby creating a compound food article. The middle pan has a pan body with a curved side wall and a flat circular bottom surface. One side of the pan body is provided with a flat handle which fits between the two parallel handles of the top pan and bottom pan and the other side of the middle pan has a support member which extends away from the sidewall and is mounted in the elevation member of the bottom pan. The pans have heat conductive cooking surfaces with a protective non-stick coating on both the outer surface portion and the inner surface with the flat handle of the middle pan fitting between the two parallel handles of the top pan and bottom pan.

It is an object of this invention to provide a cooking pan assembly used for cooking liquids or semi-liquids such as pancake batter or omelets or other food items so that the same forms a reservoir in the cooked food product to receive and hold a food filling such as syrup, fruit, confectionery or other food item.

It is another object of this invention to provide a cooking pan assembly having a middle pan which can be elevated within the bottom cooking pan to provide for cooked products of various thicknesses.

It is still another object of the invention to provide a cooking pan assembly which can be easily manufactured and used by the end user.

It is yet another object of the invention to provide a cooking pan assembly which can be easily dissembled, washed and cleaned.

It is another object of the invention to provide a cooking pan assembly which can be easily adjusted by the end user.

Still another object of the invention is to provide a cooking pan assembly that has one or more of the characteristics discussed above but which is relatively simple to use and requires a minimum of cooking skills.

The above and other objects, feature and advantages of the present invention will be apparent in the following detailed description thereof when read in conjunction with the appended drawings wherein the same reference numerals denote the same or similar parts throughout the several views.

### BRIEF DESCRIPTION OF THE DRAWINGS

The invention will be better understood and objects other than those set forth above will become apparent when consideration is given to the following detailed description thereof. Such description makes reference to the annexed drawings wherein.

FIG. 1 is a perspective view of the pan assembly when closed during the cooking process;

FIG. 2 is a perspective view of the open pan assembly with the middle pan shown mounted in a lower elevation on the bottom pan;

FIG. 3 is an exploded perspective view of the pan assembly shown in FIG. 2;

FIG. 4 is an enlarged cross sectional view of the middle pan mounted in the bottom pan at the middle pan's lowest position in the bottom pan;

FIG. 5 is an enlarged cross sectional view of the middle pan mounted in the bottom pan at the middle pan's highest position in the bottom pan;

FIG. 6 is a perspective view of the top pan and bottom pan in open position showing the handle of the bottom pan with the slide height adjustment member in exploded view;

FIG. 7 is a side elevational view of the top pan and the bottom pan of the pan assembly in a closed position;

FIG. 8 is a perspective view of the middle pan of the pan assembly;

FIG. 9 is an enlarged perspective view of a handle of the bottom pan;

FIG. 10 is a top plan view of the top pan body with hinges and handle removed;

FIG. 11 is a top plan view of the bottom pan body with hinges and handle removed;

FIG. 12 is a top perspective view of the bottom handle slide adjustment member;

FIG. 13 is a bottom perspective view of the bottom pan slide shown in FIG. 12;

FIG. 14 is a front elevational view of the bottom pan slide shown in FIG. 12;

FIG. 15 is a bottom plan view of the bottom pan slide shown in FIG. 12;

FIG. 16 is a rear elevational view of the bottom pan slide shown in FIG. 12;

FIG. 17 is a cross section of FIG. 15 taken along lines 17′-17′;

FIG. 18 is a top plan view of the bottom pan slide shown in FIG. 12; and

FIG. 19 is a side elevational view of the bottom pan slide shown in FIG. 12.

### DETAILED DESCRIPTION OF THE INVENTION

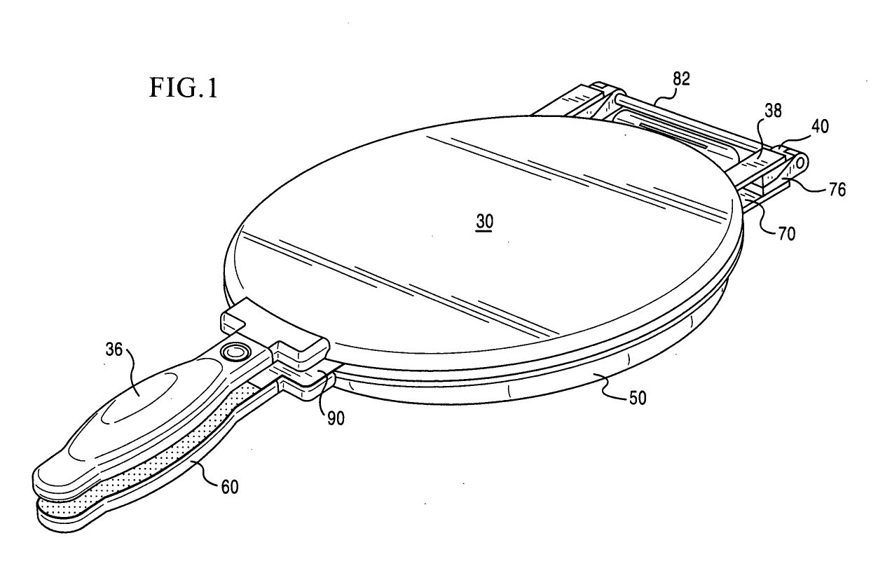

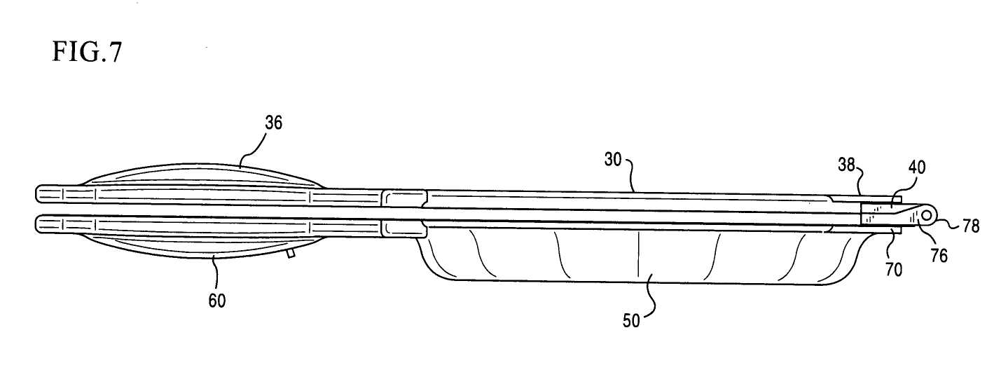

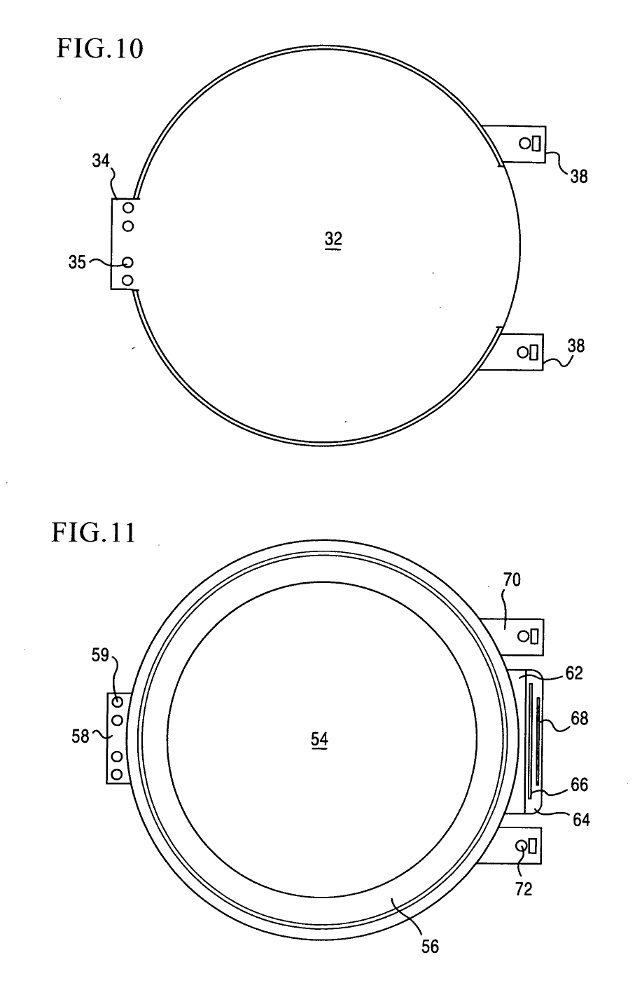

The preferred embodiment and best mode of the invention is shown in FIGS. 1 through 19. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

The present invention refers to a cooking pan assembly used for cooking food which is initially is in a liquid or semi liquid-form which solidifies and conforms to the shape of the pan when cooked with the resultant cooked food product having a central depression or cavity into which another food component or filling such as whipped cream, sauces, fruit, vegetables, meat, cheese, nuts or the like can be placed. When using the middle pan to make a thinner cooked food, wrapped dishes such as crepes, burritos, and tamales can be made.

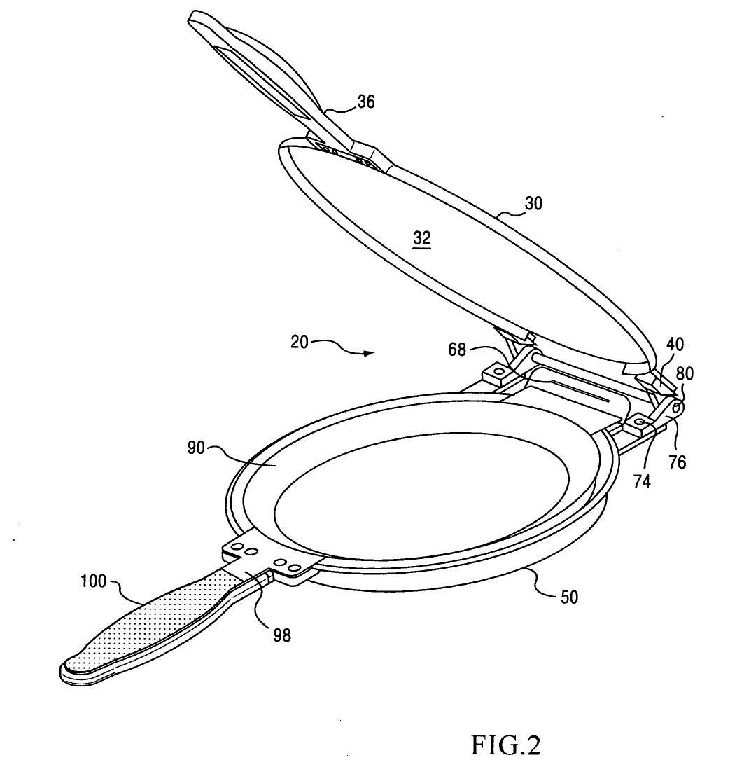

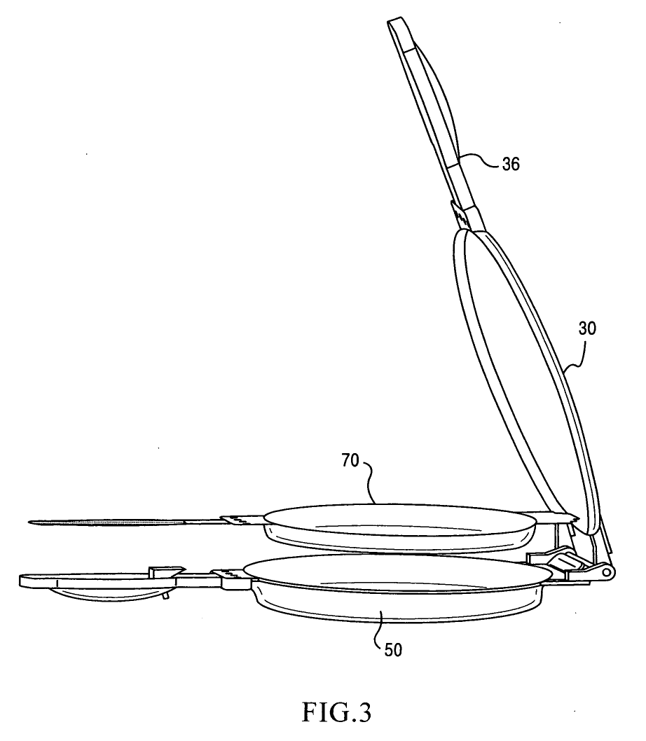

Referring now to the drawings and in particular FIGS. 2 and 3, the present invention is shown as a cooking pan assembly 20 that has a flat top pan 30 which is pivotally mounted to a bottom pan 50 and a middle pan 70 which is removably mounted to the bottom pan 50. The top pan 30 has a circular flat body 32, an integral handle mount support member 34 secured to the body which extends outward from the body 32 and an ergonomically shaped handle 36 which is riveted to handle mount member 34. The handle mount member 34 defines a plurality of rivet holes 35 allowing the shaped handle 36 to be mounted thereon. The opposite side of the circular flat body 32 has hinge mounts 38 upon which hinge pivot members 40 are mounted by rivets or other suitable fastening means. The hinge pivot member 40 defines a throughgoing bore (not shown) which is adapted to receive a cylindrical connector rod 82 upon which the hinge pivot member rotates.

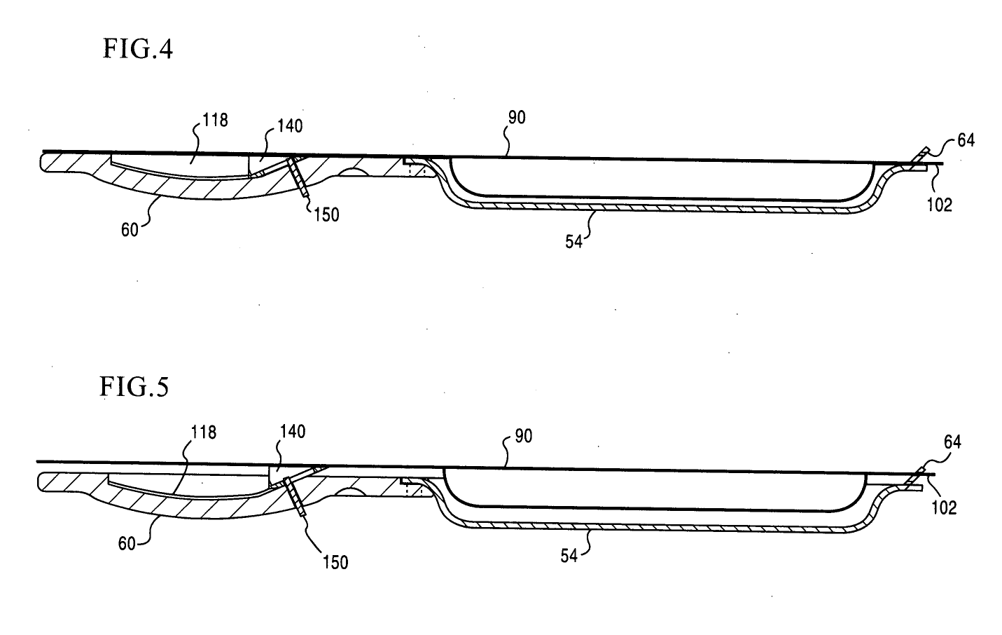

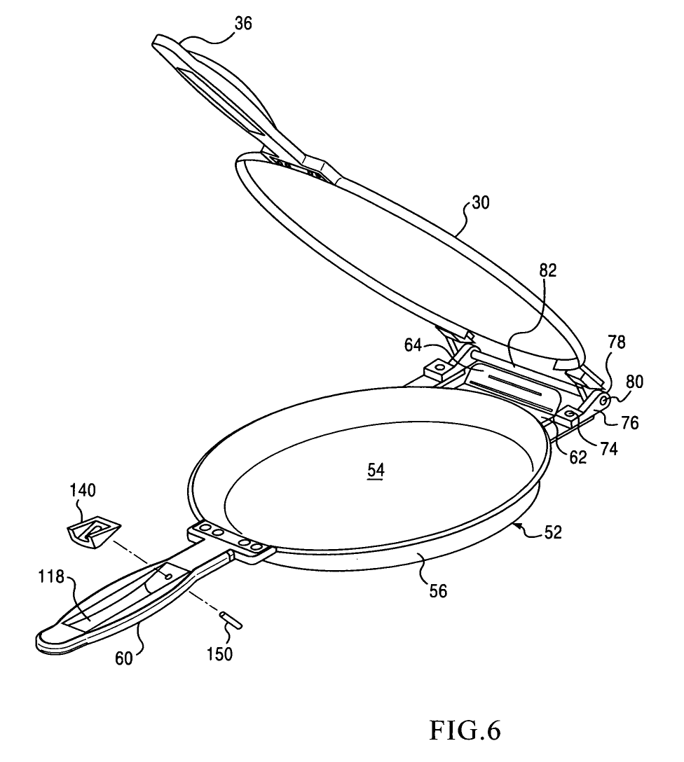

A bottom pan 50 is pivotally mounted to the top pan 30. The bottom pan 50 as seen in FIGS. 3-7 and 11 has a pan body 52 with a circular flat bottom 54 and a curved sidewall 56. A handle mount support member 58 defining a plurality of throughgoing holes 59 is secured to one portion of the sidewall 56 and an angled elevation member 62 is secured to the sidewall 56 opposite the handle support 58. The handle support 58 is riveted or fastened with other fastening means to an ergonomically shaped handle 60 which will be described in more detail later on in the description of the invention. The elevation member 62 as most clearly shown in FIGS. 6 and 11 is constructed of an angled member having an upwardly extending portion 64 which defines two parallel slots 66 and 68. Slot 66 is longer than slot 68 and is adapted to receive the stepped end portion 108 of the middle pan support member 102 so that the step stop 109 abuts against the inner surface area of portion 64. This relationship is seen in cross section in FIG. 4. The smaller slot 68 is adapted to receive step portion 106 of support member 102 so that stop 107 abuts against the inner surface area of elevation member portion 64. This relationship is seen in cross section in FIG. 5. Hinge support members 70 are secured to the sidewall 56 and extend outward from the sidewall, one on each side of the elevation member 62. The hinge support members 70 are flat and define holes 72 which receive fasteners such as rivets or pins 74 to hold pivot member 76 in position. The proximal end 77 of each pivot member 76 is preferably planar and wider than the distal end 78 which is rounded and defines a throughgoing bore 80 which holds a cylindrical pivot rod 82. The pivot rod 82 also holds the top pan hinge pivot members 40 which are positioned adjacent the bottom pan hinge pivot members 76.

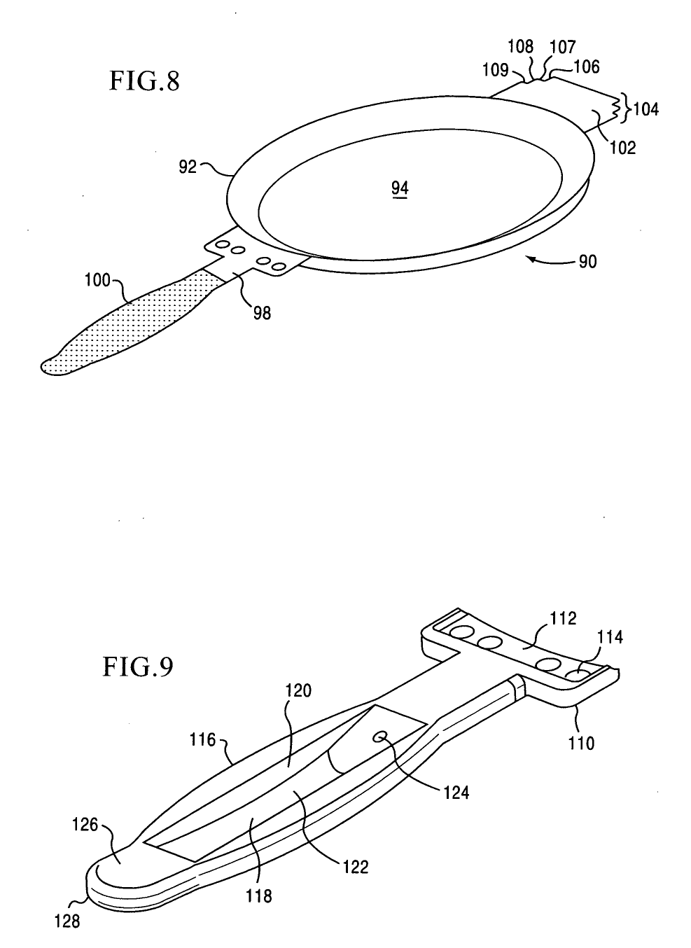

The middle pan 90 as shown in FIGS. 2 and 8 has a pan body 92 having a flat circular planar bottom 94 and a curved side wall 96 which extends upward from the bottom 94. A flat handle 98 is secured to one portion of sidewall 96. The flat handle 98 is covered with an insulating coating 100 which allows gripping by the user for removal of the same from the pan assembly. A pan elevation support member 102 is secured to sidewall 96 opposite the handle 98. The pan support member 102 is provided with a stepped cut end surface 104 which fits in the respective slots 66 and 68 of the bottom pan elevation member 62. Thus, stepped portion 106 fits in upper slot 68 of the elevation member 62 and stepped portion 108 fits in the lower slot 66 of the elevation member 62. The bottom portion 107 and 109 of each respective step 106 and 108 forms a stop which abuts against the outer wall at the end of the respective slots 68 and 66 of the elevation member 62.

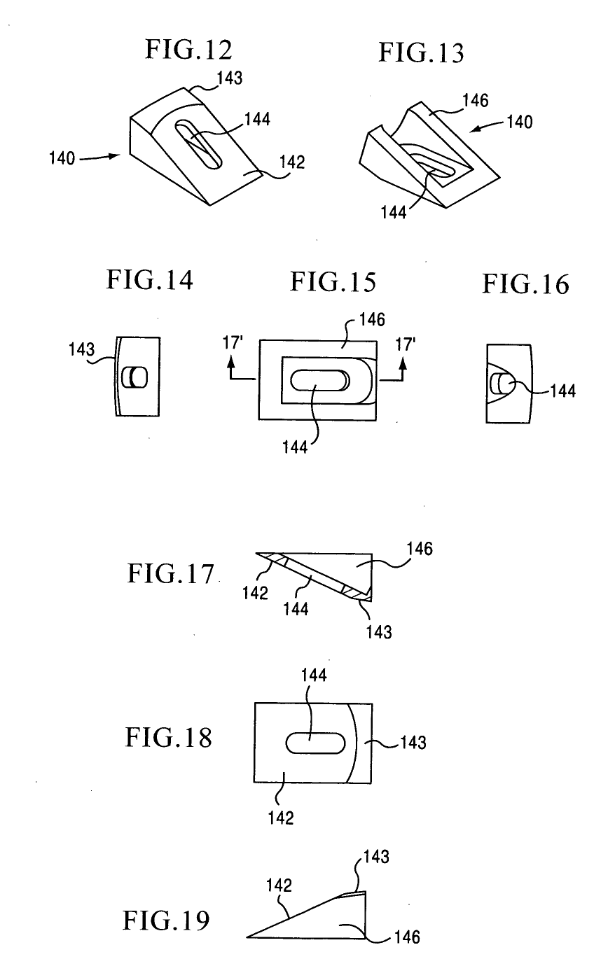

The shaped handles 36 and 60 of the top pan and the bottom pan (the bottom pan handle being shown in FIG. 9) respectively are formed with a proximal mount section 110 defining a shaped recess or cutout 112 which can receive handle mount support 34/58. The floor of the recess defines a plurality of throughgoing holes 114. The recess 112 is designed to be shaped so that it fits over the respective handle mount support members of the top and lower pans with the holes 114 being aligned with the mounting holes 35 and 59 of handle mounts support members of the top pan and lower pan respectively so that the same can be riveted together or fastened with other fasteners. Extending from the proximal section 110 of the handle is an intermediate curved portion 116 defining a channel 118 having vertical sidewalls 120 and an inclined or curved bottom surface 122. In the bottom pan handle 60, a slider adjustment hole 124 is located in the bottom surface and extends through the handle body opening into channel 118. The distal end 126 of the handle has a rounded solid end 128. A slide member 140 as shown in FIGS. 12-19 is mounted in channel 118 and can be raised by a camming action when slid along the bottom of channel 118 as shown in FIGS. 4 and 5 so that the middle pan 90 is placed in a spaced context depending on whether the upper or lower slots 68 and 68 of the elevation member 62 are being used.

The slide member 140 is shown in FIGS. 12-19. The slide member 140 has a planar surface portion 142 which defines a slot 144 and a rear portion 143 cut at a lesser angle than that of planar surface 142. Angled sidewalls 146 extend upward from the planar surface portion 142 forming a central cavity 148. The slide height adjustment member 140 is slid along the channel 118 with a guide pin 150 mounted in the slot 144 which raises the elevation of the slide member 140 and the handle 98 of the middle pan. At the lower elevation as shown in FIG. 4 the slide height adjustment member will be located in a lower position in the channel 118 of the handle. The slide member 140 is inverted as shown in FIGS. 4, 5 and 13 and is slid along guide pin 150 which has a friction fit with slot 144 so that it has a corresponding elevation with slot 68 and 66.

The pan surfaces of the top, bottom and middle pans as well the handles and bottom surface of the middle pan are preferably coated with one or more nonstick coatings, such as for example TEFLON® (i.e., fluorocarbon polymers), (e.g., tetrafluroethlene and fluorinated ethylene propylene). The respective pans can be constructed of sheet steel, stainless steel, copper, aluminum, cast iron, Pyrex®, glass, porcelain, ceramic or any type of microwaveable material at a uniform desired thickness commonly used for baking pans and containers.

In operation, the liquid of the pancake batter or the eggs is placed in the bottom cooking pan 50. The middle pan support member 102 is inserted in a selected slot 66 or 68 of the elevation member 62 with the handle elevation slide member 140 being accordingly adjusted so that the height of the middle pan and conversely the depth that the middle pan extends into the cavity of the bottom pan a desired distance. The middle pan handle 98 is then laid against the upper surface of bottom pan handle 60 (FIG. 4) or against the top of the slide member 140 (FIG. 5) depending upon the elevational relationship desired with the bottom flat surface 94 of the middle pan body 92 extending into the concave pan section of the bottom pan 50 and engaging the cooking liquid in the bottom pan 50. The top pan 30, middle pan 90 and bottom pan 50 together cook the batter or liquid mixture so that a depression or reservoir is formed in the cooked product. This depression or reservoir will have the same general dimensions and shape as the middle pan sidewall 96 and circular planar bottom 94. When the food product is fully cooked, the cooking pan assembly 20 is opened on its hinges and the middle pan 90 removed with the cooked food positioned on the back surface of the bottom surface 94, it being noted that the bottom surface 94 is now the supporting structure. The cooked food is then removed to a serving tray or plate leaving a cooked product with a depression or reservoir into which a filling material can be later added.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What I claim is:

1. A cooking pan assembly comprising; a top pan pivotally mounted to a bottom pan, said bottom pan defining a reservoir and a handle mounted to and extending from said bottom pan, a middle pan defining a reservoir which has a lesser surface area than that of the bottom pan reservoir removably mounted to the bottom pan with the middle pan extending into the reservoir of the bottom pan, a handle mounted to said middle pan, said bottom pan being provided with elevation means which allows said middle pan to selectively mounted at different heights in relation to said bottom pan.

2. A cooking pan assembly as claimed in claim 1 wherein said middle pan comprises a pan body with a side wall defining a cavity and a flat circular bottom, a handle secured to said pan body and an elevation support member extending from said side wall.

3. A cooking pan assembly as claimed in claim 2 wherein said middle pan handle is planar on its top and bottom surface, with at least a portion of the handle being coated with a thermal insulation material.

4. A cooking pan assembly as claimed in claim 1 wherein said elevation means comprises an elevation member mounted to said bottom pan and extending from said bottom pan, said elevation member defining a plurality of parallel slots.

5. A cooking pan assembly as claimed in claim 4 further including a slide member slidably mounted in said bottom pan handle.

6. A cooking pan assembly as claimed in claim 1 wherein said top pan, said middle pan and said bottom pan have at least one surface coated with a nonstick coating.

7. A cooking pan assembly as claimed in claim 6 wherein said nonstick coating is tetrafluroethlene

8. A cooking pan assembly as claimed in claim 6 wherein said nonstick coating is fluorinated ethylene propylene

9. A cooking pan assembly as claimed in claim 3 wherein said middle pan handle defines a plurality of holes therethrough.

10. A cooking pan assembly as claimed in claim 2 wherein said elevation support member has a planar surface with a stepped end.

11. A cooking pan assembly comprising; a top pan body pivotally mounted to a bottom pan body, said bottom pan body defining a reservoir, a handle mounted to and extending from said bottom pan body, a middle pan body defining a reservoir which has a lesser surface area than that of the bottom pan mounted to the bottom pan with the middle pan body extending into the reservoir of the bottom pan, a handle mounted to said middle pan body, said middle pan body having a side wall defining a cavity and a flat bottom, a handle secured to said pan body and an elevation support member extending from said side wall opposite said handle, said bottom pan being provided with elevation means which allows said middle pan to be selectively mounted at different heights in relation to said bottom pan, said elevation means comprising an elevation member mounted to said bottom pan body and extending from said bottom pan body, said elevation member defining a plurality of apertures which receive said elevation support member of said middle pan.

12. A cooking pan assembly as claimed in claim 11 wherein said middle pan body is thermally conductive and includes a surface coating that provides a non-stick cooking surface while cooking.

13. A cooking pan assembly as claimed in claim 11 wherein said middle pan handle is planar.

14. A cooking pan assembly as claimed in claim 13 wherein said middle pan handle defines a plurality of holes.

15. A cooking pan assembly as claimed in claim 11 wherein said bottom pan handle defines a channel therein and a slide member is mounted in said channel.

16. A cooking pan assembly as claimed in claim 15 wherein said slide member has an inclined surface which defines a slot therein.

17. A cooking pan assembly as claimed in claim 16 wherein a pin member is mounted to said bottom pan handle and extends into said slot of said slide member frictionally engaging said slot.

18. A cooking pan assembly as claimed in claim 11 wherein said middle pan elevation support member has a planar portion with a stepped end adapted to be mounted to bottom pan elevation member and said bottom pan apertures are a plurality of parallel slots.

19. A three pan cooking assembly comprising; a top pan pivotally mounted to a bottom pan and a middle pan adapted to be mounted between said top pan and said bottom plan, said bottom pan having a body defining a reservoir and a handle mounted to and extending from said bottom pan body, a middle pan having a body defining a reservoir which has a lesser surface area and depth than that of the bottom pan reservoir mounted to the bottom pan with the middle pan body extending into the reservoir of the bottom pan, a handle mounted to said middle pan body, said middle pan body having a flat bottom surface, a flat handle secured to said middle pan body and an elevation support member extending from said body across from said handle, said bottom pan being provided with elevation means which allows said middle pan to selectively mounted at different heights in relation to said bottom pan, said elevation means comprising an elevation member mounted to said bottom pan body and extending from said bottom pan body, said elevation member defining a plurality of parallel slots which receive said elevation support member of said middle pan, and means moveably mounted in said bottom pan handle to selectively elevate said middle pan handle.

20. A cooking pan assembly as claimed in claim 19 wherein said elevation support member is planar with a stepped end and said bottom pan elevation member's parallel slots have a length to receive different stepped end portions of said elevation support member.

21. A cooking pan assembly as claimed in claim 19 wherein said bottom pan handle selective elevation means comprise a channel which houses a slide member which engage the middle pan handle to selectively elevate same.

22. A cooking pan assembly as claimed in claim 21 wherein said slide member comprises a slide member with an inclined surface and a movable guide means mounted on said bottom pan handle to engage said slide member.
